(19) United States
(12) Patent Application Publication
(10) Pub. No.: US 2006/0034305 A1
(43) Pub. Date: Feb. 16, 2006

(54) Anomaly-based intrusion detection

(75) Inventors: Walter L. Heimerdinger, Minneapolis, MN (US); Valerie Guralnik, Orono, MN (US); Ryan A. VanRiper, Maple Grove, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/189,446

(22) Filed: Jul. 26, 2005

Related U.S. Application Data
(60) Provisional application No. 60/601,465, filed on Aug. 13, 2004.

(51) Int. Cl. H04L 12/56

(52) U.S. Cl. 370/408

(57) ABSTRACT

Anomaly detection technology is used to detect attempts at remote tampering of communications used to control components of critical infrastructure. Intrusions in a control network are detected by monitoring operational traffic on the control network. Activity outside a normal region is identified, and alerts are provided as a function of identified activity outside the normal region. A stide algorithm may be used to identify such activity.

### RELATED APPLICATIONS

This application claims priority to U.S. Provisional Application Ser. No. 60/601,465 (entitled ANOMALY-BASED INTRUSION DETECTION, filed Aug. 13, 2005) which is incorporated herein by reference.

### BACKGROUND

The fragility of the power grid and the potential impact of power grid failure is known to potential attackers. Supervisory Control and Data Access (SCADA) systems or facilities can be subject to a remote asymmetric attack. Such attacks can occur via direct access and via public networks, such as the Internet. An attack on SCADA facilities could extend the time and severity of damage from a physical attack. Tools are lacking to detect attempts at remote tampering. There is a significant risk that there may be deliberate attacks that could result in extended outage if better tools are not available.

### SUMMARY

Anomaly detection technology is used to detect attempts at remote tampering of communications used to control components of critical infrastructure. A method of detecting intrusions in a control network involves monitoring operational traffic on the control network. Activity characteristic of a normal region is identified, and alerts are generated if activity outside this normal region is identified.

### BRIEF DESCRIPTION OF THE DRAWINGS

FIG. 1 is a block diagram of a control network according to an example embodiment.

FIG. 2 is a block diagram illustrating the environment used for learning normal behavior for a control network according to an example embodiment.

FIG. 3 is a block diagram illustrating tokenization of communications on a control network and pattern matching sequences of these tokens to determine anomalous behavior according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

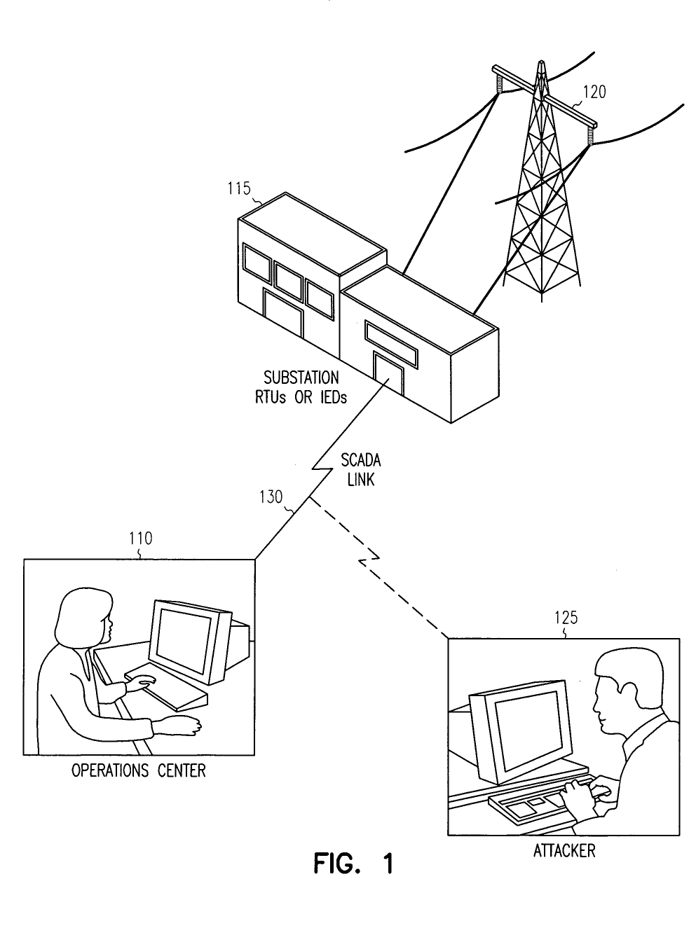

A networked supervisory control and data access system (SCADA) can be subject to remote attacks via a network. One simplified example network is shown in FIG. 1, where an operations center 110 is used to monitor and control a power grid, including a substation 115 and power line 120. The substation 115 may have one or more remote terminal units (RTUs) or intelligent electronic devices (IEDs) that communicate regularly with operations center 110, such as by responding to requests from a master in the operations center 110, and one or more IEDs that measure and control power distribution based on received commands, and can operate to change the settings of circuit breakers, tap changers, and other distribution network operating devices. Other components may also be included in the network, such as multiple substations and power lines, each having many devices coupled to the network.

An attacker is represented at 125, and attempts to attack the operations center via a network connection to a link 130 between the operations center and the substation. The link may be a public network like the Internet, or may even be a private network that the attacker has broken into.

An attacker may attempt to manipulate data streams on the link 130 to precipitate a large-scale outage of power. Existing signature based detectors look for fragments of known exploits. A machine recognizable description of the exploit is required, but is limited to fairly specific and known exploits.

In one embodiment of the present invention, anomaly detection is used to look for activity outside a known or learned normal region. An anomaly is an event that is not normal. Events include communication events, grid events and attacks. Examples of communication events are control messages and measured data exchanged between a master station and remote station. Normal communication may also be subject to random disturbances (noise). Grid events include maintenance activities and externally caused events such as storms and outages. Both communication and grid events are examples of normal events. In one embodiment, anomaly detection is used to report malicious events such as attacks. Both normal and anomalous events are inferred from examination of messages, message sequences or parts of a single message.

Hostile parties, referred to as attackers 125 may read traffic and submit messages that can be read by others coupled to the network. Hostile parties can learn of configurations of remote switchgear via monitoring network communications, such as distributed network protocol (DNP) message monitoring and other means. DNP3 is a common network protocol used over leased line, frame relay, wide area networks and the Internet. While DNP is used as an example, other networks with different protocols may be used. The hostile party may then attempt to operate remote equipment and/or confuse a master station operator with misleading data. Such a hostile party can also prevent control by an operator through interference techniques. The actions of hostile parties may not be predictable, leading to ineffectiveness of signature based detection mechanisms.

In operation, the anomaly detection mechanism monitors system operational traffic, such as sequences of messages. It looks for activity outside a known or learned normal region and alerts if such activity persists beyond some threshold. A pattern matching algorithm may be applied to detect such activity.

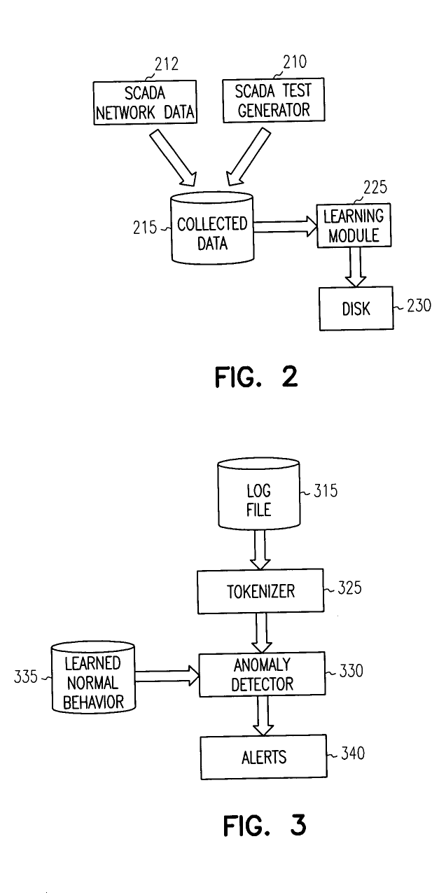

A normal region may be characterized by creating calibration data as shown in a block diagram of a testing configuration in FIG. 2. Data may be collected from actual network messages 212 over an extended period and/or generated by a test generator 210. Typical modes of operation are included in the simulated data 210 and/or actual network data 212, such as normal polling for remote terminal unit values, storm effects and typical maintenance operations. In some embodiments, two percent of simulated data is garbled to simulate line disturbances. A master log file, referred to as collected data 215 may be maintained of collected communications. In one embodiment, simulated data is provided to simulate rare events, while most of the calibration data is provided from real operating data via collected data 212.

Actual collected network data 212 may be obtained via the use of one or more data collectors. A data collector may extract data from the master station log file at an operations center 110. Further data collectors may be used to capture data from log files at RTUs and IEDs, or by direct coupling to various network components.

In one embodiment, the calibration data is from a control network that includes at least one master station, and multiple simulated RTUs. In this embodiment, simulated DNP3 data is recorded in the master station log, representing normal activity. Both application and data link layer part of DNP3 messages may be translated or abstracted into tokens that capture important information in a stream of messages. The tokens can then be used by learning algorithms. A learning algorithm, referred to as learning module 225 is used to provide a model of normal activities to be used by an anomaly detector to generate alerts if any anomalies are detected. The model is referred to as learned normal behavior, as indicated at a storage device such as a disk 230.

As indicated previously, information from communications is extracted and abstracted or converted into tokens. This occurs both during training, and during normal operation when searching ongoing communications for malicious activity. Data associated with both data link and application layers in the communication protocol is used. The data link layer data provides information that describes network communication. The application layer data provides the status of SCADA system components.

Learning module 225, in one embodiment, converts the collected data into tokens, and determines sequences of tokens that are likely to occur during normal behavior of the system. Many different types of learning algorithms may be used to determine which sequences represent normal behavior. In a further embodiment, tokenization may occur prior to the learning module 225.

The following token components represent a data link layer part of the message in one example embodiment:
PRM_INDICATOR identifies the initiator of the dialog. If the indicator is set to “PRM” the message is initiated by the Primary initiator; if it is set to “SEC” the message is initiated by the Secondary.
DIRECTION bit represents whether the message is from the master or from an RTU.
FCB_BIT indicates the validity of the frame as related to losses or duplication.
FCV_BIT indicated whether or not the FCB bit should be ignored.
DFC_BIT indicates buffer overflow.
DESTINATION_ADDRESS is an address of the message receiver.
SOURCE_ADDRESS is an address of the message initiator.
FUNCTION CODE identifies a purpose of frame from the data link layer point of view.

The following token components represent an application link layer portion of the message:
COMMAND specifies what the master station wants an RTU to do. Each command may have zero or more parameters. This token component applies to a message from the master station.
INTERNAL INDICATORS applies to messages sent by an RTU. It indicates whether or not the requested information is available.
SEQ_NUMBER_MSG_TYPE applies to messages sent by an RTU. It indicates whether or not the data being sent was requested by the master.
RESPONSE_CODE applies to messages sent by an RTU. It indicates the purpose of the message in terms of the application layer.
OBJECT TYPE token component applies to messages sent by an RTU. Object type refers to a particular part of the RTU, and it indicates the status of that part.
   There are more then 100 possible object types. Seven types of objects are included in this component:
Analog input data
Binary input with status
Binary input change without time
Binary output status
Control Relay output block
Time and Date
Class 0, 1, 2 or 3 Data

In general, a token that represents a message from the master to an RTU has the following format: <PRM_INDICATOR>+<FUNCTION_CODE>+<DIRECTION>+<FCV_BIT>+<F CB_BIT>+<DFC_BIT>+<DESTINATION_ADDRESS>+<SOURCE_ADDRESS>+[<COMMAND>(<COMMAND_PARAMS>)*]*

A token that represents a message from an RTU to a master has the following format: <PRM_INDICATOR>+<FUNCTION_CODE>+<DIRECTION>+<FCV_BIT>+<F CB_BIT>+<DFC_BIT>+<DESTINATION_ADDRESS>+<SOURCE_ADDRESS>+<SEQ_NUMBER_MESG_TYPE><RESPONSE_CODE><INTERNAL_INDICA TORS>(<OBJECT_TYPE>(<OBJECT_PARAMETER>)+)*

For a message being discarded due to a CRC errors, the token takes the following form:

CRC_ERROR+<DIRECTION>

In one embodiment, the method builds a model of normal behavior by making a pass through the training data and storing each unique contiguous token sequence of a predetermined length in an efficient manner. When the method is used to detect intrusions, the sequences from the test set are compared to the sequences in the model. If a sequence is not found in the normal model, it is called a mismatch or anomaly.

In one embodiment, network data from one or more sources is collected in a log file 315. The network data is tokenized as indicated at 325. A detection algorithm such as anomaly detector 330 is used to detect malicious activity. In one embodiment, the anomaly detector 330 is a variation of a sequence time delay embedding (STIDE) anomaly detection algorithm. The algorithm uses tokens created from the log file 315. The algorithm compares groups of contiguous tokens (n-grams) created from the log file 315 to groups of tokens from a model of learned normal behavior 335 of non-anomalous activity. In one embodiment, anomaly detector 330 uses a sliding window pattern matcher to compare current data, or recent data from the log to the learned normal behavior.

In one embodiment, a sequence length of one to three may provide a low false positive rate, yet achieve sufficient detection of anomalies. A false positive rate may increase with longer representative sequences, such as those numbering four to six. In further embodiments, significantly longer or shorter sequence lengths may provide a desired balance between false negative and false positive detection. The length may depend on individual network characteristics or other factors. In a further embodiment, the false positive rate may be reduced by aggregation of consecutive anomalies and a more generalized tokenization approach.

Alerts 340 may be generated when patterns in the current data do not match patterns from the learned normal behavior for a predetermined period of time. In further embodiment, alerting may be a function of an analysis based on probabilities given current weather and political situation, and includes a probability of an attack in progress. If known weather conditions are occurring, operational traffic that may be considered anomalous otherwise would be classified as normal traffic. However, if traffic appears that is weather related, but no known weather conditions exist, such traffic may in fact be malicious. In a further embodiment, alerting is a function of grid state, which may be based on state estimators and topology estimators. Again, it can be determined whether operational traffic is consistent with such estimators.

Several different intrusion detection scenarios may be found using the above algorithm. In one, an attacker attempts to spoof a master. It produces response that appear to be from a remote terminal unit, however, they do not follow a request from a master. In second scenario, an attacker attempts to spoof a remote terminal unit by producing multiple analog value messages that appear to be from the remote terminal unit following a single request form a master. In a denial of service scenario, an attacker produces data link layer acknowledgements from a remote terminal unit that do not follow a cold restart request from a master.

A general computing device 350 may be used to implement methods of the present invention. The computing device 350 may be in the form of a computer, may include a processing unit, memory, removable storage, and non-removable storage. Memory may include volatile memory and non-volatile memory. Computer 350 may include—or have access to a computing environment that includes—a variety of computer-readable media, such as volatile memory and non-volatile memory, removable storage and non-removable storage. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 350 may include or have access to a computing environment that includes input, output, and a communication connection. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit of the computer. A hard drive, CD-ROM, and RAM are some examples of articles including a computer-readable medium. For example, a computer program capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system to provide generic access controls in a COM based computer network system having multiple users and servers.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method of detecting intrusions in a control network, the method comprising:
monitoring operational traffic on the control network;
identifying anomalies in the operational traffic; and
alerting as a function of such anomalies.

2. The method of claim 1 wherein the operational traffic is tokenized.

3. The method of claim 1 wherein alerting is a function of a number of identified anomalies within a particular time interval.

4. The method of claim 1 and further comprising learning normal behavior on the control network by observing and/or simulating operational traffic, and wherein anomalies are identified as deviations from such learned normal behavior.

5. The method of claim 4 wherein operational traffic comprises legal protocol messages.

6. The method of claim 5 wherein information from the protocol messages is abstracted into tokens.

7. The method of claim 4 wherein modes of normal behavior comprise normal polling for remote terminal unit values, storm effects, and typical maintenance operations.

8. The method of claim 7 wherein activity outside normal behavior comprises spoofing a master, spoofing a remote terminal unit (RTU) and denial of service.

9. A method of detecting intrusions in an infrastructure control network, the method comprising:
monitoring operational traffic on the infrastructure control network;
identifying activity outside a normal region; and
alerting if such activity persists beyond a threshold.

10. The method of claim 9 wherein the infrastructure comprises a power grid.

11. The method of claim 9 and further comprising:
converting the operational traffic into tokens.

12. The method of claim 11 wherein activity is represented by token sequences; wherein
identifying activity outside a normal region is accomplished by using a sliding window pattern matcher.

13. The method of claim 10 wherein alerting is a function of an analysis based on probabilities given current weather and political situation, and includes a probability of an attack in progress.

14. The method of claim 10 wherein alerting is a function of grid state.

15. The method of claim 14 wherein grid state is a function of state estimators and topology estimators.

16. An anomaly detection system comprising:
means for monitoring operational traffic on the power grid control network;
means for converting the operational traffic into tokens;
means for identifying activity outside a normal region of behavior using a sliding window pattern matcher; and
means for alerting if such activity occurs a predetermined number of times within a particular time interval.

17. The method of claim 16 and further comprising learning the normal region of behavior on the control network by observing and/or simulating operational traffic.

18. The method of claim 17 wherein operational traffic comprises legal protocol messages.

19. The method of claim 18 wherein information from the protocol messages is abstracted into tokens.

20. The method of claim 16 wherein the normal region of behavior comprises normal polling for remote terminal unit values, storm effects, and typical maintenance operations.
